(19) United States
(12) Patent Application Publication
(10) Pub. No.: US 2024/0078848 A1
(43) Pub. Date: Mar. 7, 2024

(54) REPAIR CONTENT PREDICTION METHOD, REPAIR CONTENT PREDICTION DEVICE, COMPUTER-READABLE RECORDING MEDIUM RECORDING A PROGRAM, AND METHOD FOR CREATING REPAIR CONTENT PREDICTION MODEL

(71) Applicant: Panasonic Intellectual Property Corporation of America, Torrance, CA (US)

(72) Inventor: Takaaki FUKUNISHI, Osaka (JP)

(73) Assignee: Panasonic Intellectual Property Corporation of America, Torrance, CA (US)

(21) Appl. No.: 18/509,017

(22) Filed: Nov. 14, 2023

Related U.S. Application Data
(63) Continuation of application No. PCT/JP2022/019533, filed on May 2, 2022.

(30) Foreign Application Priority Data
May 17, 2021 (JP) 2021-083301

(51) Int. Cl. G07C 5/00; B60L 58/16

(52) U.S. Cl. CPC G07C 5/006; B60L 58/16

(57) ABSTRACT

The information processing device acquires operation history information and failure state description information about a device to be repaired, predicts a repair content candidate for the device to be repaired based on the learned repair content prediction model and the acquired operation history information and the failure state description information, and outputs the predicted repair content candidate.

### TECHNICAL FIELD

The present disclosure relates to a repair content prediction method, a repair content prediction device, a computer-readable recording medium recording a program, and a method for creating a repair content prediction model.

### BACKGROUND ART

Non Patent Literature 1 below discloses a technology to predict repair content candidates for a device to be repaired based on a failure state description about the device to be repaired and a learned prediction model.

However, with the technology disclosed in Non Patent Literature 1, prediction accuracy of the repair content candidates is insufficient.

### CITATION LIST

### Non Patent Literature

Non Patent Literature 1: “Natural language processing technology that makes one-time repair visit”, [online], Fujitsu, [searched on Apr. 1, 2021], Internet <URL: https://www.fujitsu.com/jp/group/fim/imagesgig5/01-04-zinrai04.pdf>

### SUMMARY OF INVENTION

An object of the present disclosure is to obtain a repair content prediction method, a repair content prediction device, a program, and a method for creating a repair content prediction model that can improve prediction accuracy of repair content candidates.

A repair content prediction method according to one aspect of the present disclosure includes, by an information processing device: acquiring operation history information and failure state description information about a device to be repaired; predicting a repair content candidate for the device to be repaired based on a learned repair content prediction model and the acquired operation history information and the failure state description information; and outputting the predicted repair content candidate.

### BRIEF DESCRIPTION OF DRAWINGS

FIG. 1 is a diagram showing the overall configuration of an on-site repair service system according to an embodiment of the present disclosure.

FIG. 2 is a diagram showing one simplified example of operation history data.

FIG. 3 is a diagram showing one simplified example of the operation history data.

FIG. 4 is a flow chart showing a prediction process of a repair content candidate by a server device.

FIG. 5 is a diagram showing one example of a repair content candidate screen displayed on a display device.

FIG. 6 is a flowchart showing a repair content prediction model creation process by a prediction model creation unit.

### DESCRIPTION OF EMBODIMENTS

(Knowledge Underlying the Present Disclosure)

In an on-site repair service when a device such as a home appliance fails, a service engineer visits the user's home or the like and repairs the device to be repaired. At that time, if the repair of the device to be repaired cannot be completed in one visit, useless costs for revisiting are generated, and user satisfaction is lowered.

Here, since the number of parts the service engineer can bring during the visit is limited, preferably, an operator asks the user about the failure state at the time of reception of the repair, repair content candidates are predicted based on the failure state, and the service engineer brings parts corresponding to the repair content candidates.

The repair content prediction method according to the background art described above includes: predicting repair content candidates for the device to be repaired by using a learned prediction model based on failure state description information about the device to be repaired.

However, prediction based only on the failure state description information does not provide sufficient prediction accuracy of the repair content candidates, and further improvement in the prediction accuracy is desired.

To solve such a problem, by making a prediction based on the operation history information on the device to be repaired in addition to the failure state description information, the present inventor has obtained the knowledge that the prediction accuracy of the repair content candidates can be improved, and has conceived of the present disclosure.

Next, each aspect of the present disclosure will be described.

A repair content prediction method according to one aspect of the present disclosure includes, by an information processing device: acquiring operation history information and failure state description information about a device to be repaired; predicting a repair content candidate for the device to be repaired based on a learned repair content prediction model and the acquired operation history information and the failure state description information; and outputting the predicted repair content candidate.

According to the present aspect, the information processing device acquires the operation history information and the failure state description information about the device to be repaired, and predicts the repair content candidate for the device to be repaired based on the learned repair content prediction model and the acquired operation history information and the failure state description information. In this way, by predicting the repair content candidate by using not only the failure state description information, which is subjective information obtained from the user, but also the operation history information, which is objective information indicating the behavior of the device until the device fails, it is possible to improve the prediction accuracy of the repair content candidate.

In the above-described aspect, the method may further include selecting one of a first prediction model, a second prediction model, and a third prediction model as the repair content prediction model, in which the first prediction model may be a model created by machine learning using, as teacher data, the failure state description information and repair record information about each of a plurality of faulty devices for which repair is previously executed, the model predicting a first repair content candidate based on the failure state description information, the second prediction model may be a model created by machine learning using, as teacher data, the operation history information and the repair record information about each of the plurality of faulty devices, the model predicting a second repair content candidate based on the operation history information, and the third prediction model may be a model created by machine learning using, as teacher data, the failure state description information, the operation history information, and the repair record information about each of the plurality of faulty devices, the model predicting a third repair content candidate based on the failure state description information and the operation history information.

According to the present aspect, by selecting one of the first prediction model, the second prediction model, and the third prediction model as the repair content prediction model, it is possible to further improve the prediction accuracy of the repair content candidate.

In the above-described aspect, the third prediction model may be created by combining the first prediction model and the second prediction model, and the third repair content candidate may be predicted by inputting the first repair content candidate and the second repair content candidate into the third prediction model.

According to the present aspect, it is possible to further improve the prediction accuracy of the repair content candidate.

In the above-described aspect, the method may further include calculating a degree of similarity between history data on a plurality of pieces of the failure state description information that is previously acquired and the failure state description information about the device to be repaired, in which when the degree of similarity is less than a threshold, the second prediction model may be selected as the repair content prediction model.

According to the present aspect, since the first prediction model or the third prediction model is not selected when the degree of similarity is less than the threshold because no similar failure state description information exists in the past, it is possible to avoid a decrease in the prediction accuracy.

In the above-described aspect, the method may further include calculating an accuracy evaluation value of each of the first prediction model, the second prediction model, and the third prediction model when the degree of similarity is equal to or greater than the threshold, in which a model of the first prediction model, the second prediction model, and the third prediction model with the highest accuracy evaluation value may be selected as the repair content prediction model.

According to the present aspect, by selecting a model of the first prediction model, the second prediction model, and the third prediction model with the highest accuracy evaluation value as the repair content prediction model, it is possible to further improve the prediction accuracy of the repair content candidate.

In the above-described aspect, precision or recall may be used as the accuracy evaluation value.

According to the present aspect, by using precision as the accuracy evaluation value, it is possible to reduce the number of parts to be brought for the on-site repair service. By using recall as the accuracy evaluation value, it is possible to reduce the possibility of revisiting in the on-site repair service.

In the above-described aspect, the repair content candidate may include a measure content candidate and a part candidate.

According to the present aspect, it is possible to present the measure content candidate and the part candidate to an on-site repair service engineer.

In the above-described aspect, the repair content candidate may further include confidence of the measure content candidate and confidence of the part candidate, and the repair content prediction method may further include transmitting data indicating the repair content candidate to a display device.

According to the present aspect, it is possible to present the measure content candidate and its confidence and the part candidate and its confidence to the on-site repair service engineer.

In the above-described aspect, the device to be repaired may be a battery for driving a travel motor mounted on a vehicle.

According to the present aspect, it is possible to predict the location of a failure or the like in the battery for driving the travel motor mounted on the vehicle.

A repair content prediction device according to another aspect of the present disclosure includes: an acquisition unit configured to acquire operation history information and failure state description information about a device to be repaired; a prediction unit configured to predict a repair content candidate for the device to be repaired based on a learned repair content prediction model and the operation history information and the failure state description information acquired by the acquisition unit; and an output unit configured to output the repair content candidate predicted by the prediction unit.

According to the present aspect, the acquisition unit acquires the operation history information and the failure state description information about the device to be repaired, and the prediction unit predicts the repair content candidate for the device to be repaired based on the learned repair content prediction model and the operation history information and the failure state description information acquired by the acquisition unit. In this way, by predicting the repair content candidate by using not only the failure state description information, which is subjective information obtained from the user, but also the operation history information, which is objective information indicating the behavior of the device until the device fails, it is possible to improve the prediction accuracy of the repair content candidate.

A computer-readable recording medium recording a program according to another aspect of the present disclosure causes an information processing device to execute: acquiring operation history information and failure state description information about a device to be repaired; predicting a repair content candidate for the device to be repaired based on a learned repair content prediction model and the acquired operation history information and the failure state description information; and outputting the predicted repair content candidate.

According to the present aspect, by executing the program, the information processing device acquires the operation history information and the failure state description information about the device to be repaired, and predicts the repair content candidate for the device to be repaired based on the learned repair content prediction model and the acquired operation history information and the failure state description information. In this way, by predicting the repair content candidate by using not only the failure state description information, which is subjective information obtained from the user, but also the operation history information, which is objective information indicating the behavior of the device until the device fails, it is possible to improve the prediction accuracy of the repair content candidate.

A method for creating a repair content prediction model according to one aspect of the present disclosure includes, by an information processing device, creating a repair content prediction model to predict repair content based on at least one of operation history information and failure state description information on a faulty device by machine learning using, as teacher data, the operation history information, the failure state description information, and repair record information about each of a plurality of the faulty devices for which repair is previously executed.

According to the present aspect, by creating the repair content prediction model by using not only the failure state description information, which is subjective information obtained from the user, but also the operation history information, which is objective information indicating the behavior of the device until the device fails, it is possible to improve the prediction accuracy of the repair content candidate.

The present disclosure can also implement each characteristic configuration included in such a method or device as a program to be executed by a computer or as a system operated by this program. It is needless to say that such a computer program can be distributed using a computer-readable non-transitory recording medium such as a CD-ROM, or via a communication network such as the Internet.

### Description of Embodiments

Hereinafter, embodiments of the present disclosure will be described in detail with reference to the drawings. Elements denoted with the same reference symbol in different drawings represent the same or corresponding elements. Components, placement positions of the components, connection forms, the order of operations, and the like shown in the following embodiments are one example, and are not intended to limit the present disclosure. The present disclosure is limited only by the claims. Therefore, a component that is not described in an independent claim indicating the most generic concept of the present disclosure among components in the following embodiments is not necessarily required to achieve the object of the present disclosure, but the component is described as constituting a more preferable form.

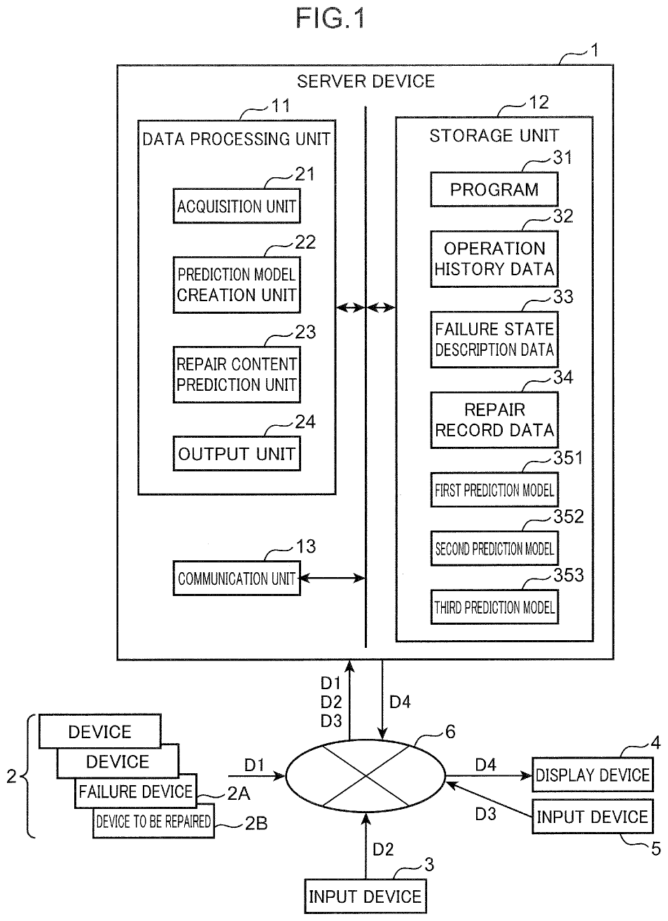

FIG. 1 is a diagram showing the overall configuration of an on-site repair service system according to the embodiment of the present disclosure. The on-site repair service system includes a server device 1, a plurality of devices 2, an input device 3 installed at a repair reception center or the like, a display device 4 and an input device 5 possessed by an on-site repair service engineer. The devices 2, the input device 3, the display device 4, and the input device 5 are connected to the server device 1 via a communication network 6. The server device 1 is a cloud server or the like. The devices 2 are IoT devices or the like having a communication function, and are, for example, a battery for driving a travel motor mounted on an electric vehicle or a hybrid vehicle, or a home appliance such as a washing machine. The input device 3 is a personal computer or the like that can be operated by an operator at the repair reception center. The display device 4 and the input device 5 are a notebook computer, a tablet, a smartphone, or the like that can be carried by the on-site repair service engineer. The communication network 6 is a dedicated line network compatible with an arbitrary communication standard such as IP or a public line network such as the Internet.

The server device 1 includes a data processing unit 11, a storage unit 12, and a communication unit 13. The data processing unit 11 includes a CPU or the like. The storage unit 12 includes an HDD, SSD, semiconductor memory, or the like. The storage unit 12 holds a program 31, operation history data 32, failure state description data 33, repair record data 34, a first prediction model 351, a second prediction model 352, and a third prediction model 353. The operation history data 32 is a database of history data in which a plurality of pieces of operation history information about the plurality of devices 2 is accumulated. The operation history information includes information such as measurement values or state values of a plurality of items representing the operation, state, or the like of each of the plurality of devices 2. The failure state description data 33 is a database of history data in which a plurality of pieces of failure state description information about the plurality of devices 2 that has previously failed is accumulated. Each of a plurality of records included in the failure state description data 33, which is a database, corresponds to the failure state description information about each of the plurality of devices 2. Hereinafter, the device 2 that has previously failed is also referred to as a “faulty device 2A”. The failure state description information is text data indicating a failure state description summarizing main points of the failure state of the faulty device 2A. The repair record data 34 is a database of history data in which a plurality of pieces of repair content information about a plurality of the faulty devices 2A that is previously repaired is accumulated. The repair content information indicates the repair content actually executed by the service engineer on the faulty device 2A.

The first prediction model 351 is a prediction model that uses the failure state description information about the device to be repaired 2 as an explanatory variable and a repair content candidate as an objective variable. Hereinafter, the device to be repaired 2 is also referred to as a “device to be repaired 2B”. The repair content candidate predicted by the first prediction model 351 is also referred to as a “first repair content candidate.” The second prediction model 352 is a prediction model that uses the operation history information about the device to be repaired 2B as an explanatory variable and the repair content candidate as an objective variable. Hereinafter, the repair content candidate predicted by the second prediction model 352 is also referred to as a “second repair content candidate”. The third prediction model 353 is a prediction model that uses the first repair content candidate and the second repair content candidate about the device to be repaired 2B as an explanatory variable and the repair content candidate as an objective variable. Hereinafter, the repair content candidate predicted by the third prediction model 353 is also referred to as a “third repair content candidate”. Alternatively, the third prediction model 353 may be a prediction model that uses the failure state description information and the operation history information about the device to be repaired 2B as an explanatory variable and the third repair content candidate as an objective variable. Note that these pieces of information held by the storage unit 12 may be physically stored in one storage medium, or may be stored in a plurality of storage media.

By the CPU executing the program 31 read from the storage unit 12, the data processing unit 11 functions as an acquisition unit 21, a prediction model creation unit 22, a repair content prediction unit 23, and an output unit 24. In other words, the program 31 is a program for causing the data processing unit 11 as an information processing device mounted in the server device 1 to function as the acquisition unit 21, the prediction model creation unit 22, the repair content prediction unit 23, and the output unit 24. The acquisition unit 21 acquires the operation history information and the failure state description information about the device to be repaired 2B.

The prediction model creation unit 22 creates the first prediction model 351 by machine learning such as a neural network using, as teacher data, the failure state description information included in the failure state description data 33 and the repair content information included in the repair record data 34. The prediction model creation unit 22 creates the second prediction model 352 by machine learning such as a neural network using, as teacher data, the operation history information included in the operation history data 32 and the repair content information included in the repair record data 34. The prediction model creation unit 22 creates the third prediction model 353 by machine learning such as a neural network using, as teacher data, the first repair content candidate, the second repair content candidate, and the repair record data 34. Alternatively, the prediction model creation unit 22 may create the third prediction model 353 by machine learning such as a neural network using, as teacher data, the failure state description information included in the failure state description data 33, the operation history information included in the operation history data 32, and the repair content information included in the repair record data 34.

The repair content prediction unit 23 inputs the failure state description information about the device to be repaired 2B acquired by the acquisition unit 21 into the learned first prediction model 351 to predict the first repair content candidate for the device to be repaired 2B. The repair content prediction unit 23 inputs the operation history information about the device to be repaired 2B acquired by the acquisition unit 21 into the learned second prediction model 352 to predict the second repair content candidate for the device to be repaired 2B. The repair content prediction unit 23 inputs the first repair content candidate output from the first prediction model 351 and the second repair content candidate output from the second prediction model 352 into the learned third prediction model 353 to predict the third repair content candidate for the device to be repaired 2B. Alternatively, the repair content prediction unit 23 may input the failure state description information and the operation history information about the device to be repaired 2B acquired by the acquisition unit 21 into the learned third prediction model 353 to predict the third repair content candidate for the device to be repaired 2B.

The output unit 24 outputs the repair content candidate predicted by the repair content prediction unit 23. Details of the processing content of each processing unit will be described later.

The device 2 periodically transmits operation history data D1 corresponding to the above-described operation history information to the server device 1 via the communication network 6. The communication unit 13 of the server device 1 sequentially receives the plurality of pieces of operation history data D1 from the device 2 and sequentially inputs the received plurality of operation history data D1 into the storage unit 12. Accordingly, the plurality of pieces of operation history data D1 received from the device 2 is accumulated in the storage unit 12 as the operation history data 32 about the device 2.

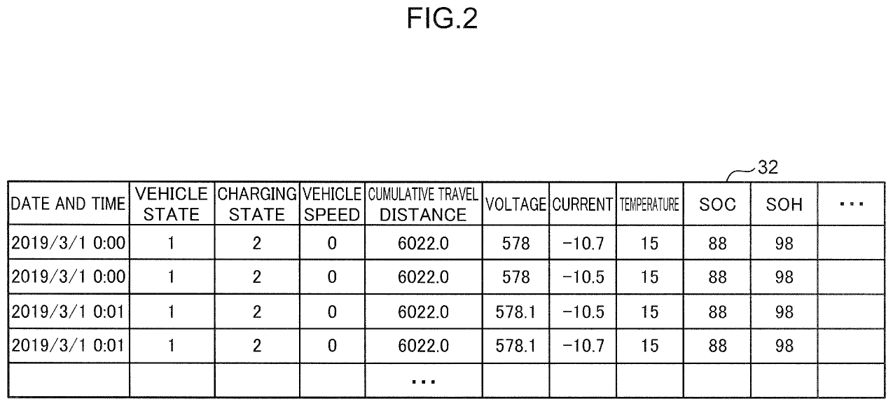

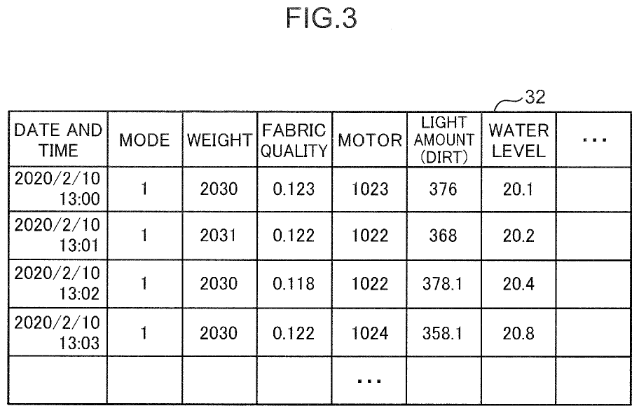

FIGS. 2 and 3 are diagrams showing one simplified example of the operation history data 32. FIG. 2 shows the operation history data 32 when the device 2 is a battery for driving a travel motor mounted on a vehicle. FIG. 3 shows the operation history data 32 when the device 2 is a washing machine. The operation history data 32 has a plurality of columns and a plurality of rows, with the columns corresponding to items representing the operation, state, or the like of the device 2, and the rows corresponding to periodic sampling times.

The plurality of items included in the operation history data 32 shown in FIG. 2 includes date and time, vehicle state, charging state, vehicle speed, cumulative travel distance, voltage, current, temperature, SOC, and SOH. Transmission date and time information on the operation history data D1 is input into the item of date and time. Flag information indicating the vehicle state, such as traveling or stopping, is input into the item of vehicle state. Flag information indicating the charging state of the battery, such as charging or discharging, is input into the item of charging state. Vehicle speed information on the vehicle is input into the item of vehicle speed. Cumulative travel distance information on the vehicle is input into the item of cumulative travel distance. Information indicating the voltage value, the current value, the temperature value, the SOC value, and the SOH value of the battery mounted on the vehicle is input into the items of voltage, current, temperature, SOC, and SOH, respectively.

The plurality of items included in the operation history data 32 shown in FIG. 3 includes date and time, mode, weight, fabric quality, motor, light amount (dirt), and water level. Transmission date and time information on the operation history data D1 is input into the item of date and time. Flag information indicating the operating mode of the washing machine is input into item of mode. Weight information on laundry is input into the item of weight. Fabric quality information on laundry is input into the item of fabric quality. Driving information such as the rotational speed of the motor is input into the item of motor. Light amount information corresponding to the dirt level of laundry is input into the item of light amount (dirt). Water level information in a washing tub is input into the item of water level.

<Use Phase>

With reference to FIG. 1, the user who requests repair of the failed device to be repaired 2B accesses the repair reception center by telephone or the like. The operator of the repair reception center answers the telephone call from the user and finds out about the failure state of the device to be repaired 2B from the user. The failure state includes the location of the failure, possible cause of the failure, error code, and the like. The operator inputs the failure state description, which summarizes main points of the failure state obtained from the user, into the input device 3 by a keyboard operation, voice input, or the like. The input device 3 transmits the failure state description information such as text data indicating the failure state description to the server device 1 via the communication network 6 as failure description data D2. The server device 1 stores the failure description data D2 received from the input device 3 into the storage unit 12 as one record of the failure state description data 33, which is a database.

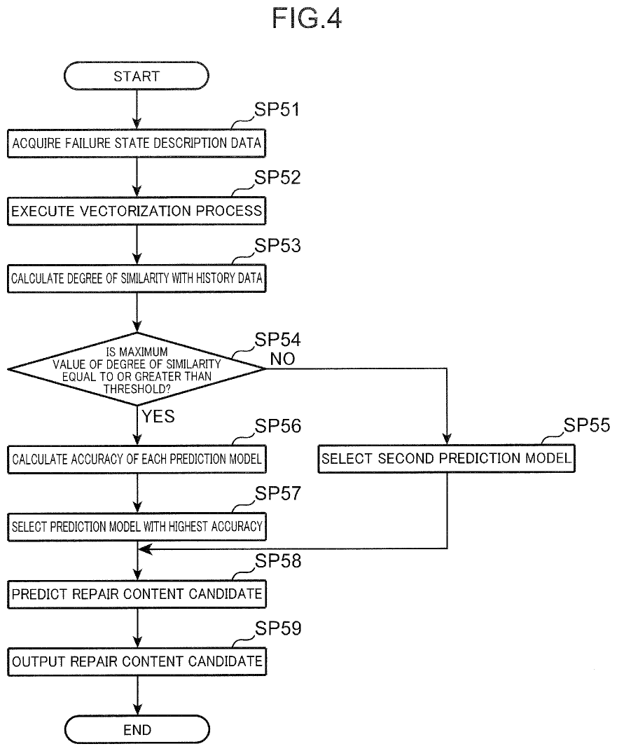

FIG. 4 is a flow chart showing a prediction process of the repair content candidates by the server device 1. To begin with, in step SP51, the acquisition unit 21 acquires the operation history data 32 and the failure state description data 33 about the device to be repaired 2B by reading from the storage unit 12. The acquisition unit 21 acquires the first prediction model 351, the second prediction model 352, and the third prediction model 353 by reading from the storage unit 12. The first prediction model 351, the second prediction model 352, and the third prediction model 353 are created in advance by the prediction model creation unit 22. Details of the learning phase for creating these prediction models will be described later.

Next, in step SP52, by using a vectorization method such as the Bag Of Words method, the repair content prediction unit 23 executes a vectorization process on the failure state description indicated by the failure state description data 33 about the device to be repaired 2B. In the Bag Of Words method, the failure state description is divided into words, and the number of occurrences of each word is counted. Note that the method for the vectorization process on documents is not limited to the Bag Of Words method, and an arbitrary method such as the TF-IDF method, the Doc2Vec method, the Sent2Vec method, or the like can be used.

Next, in step SP53, the repair content prediction unit 23 calculates the degree of similarity between the failure state description corresponding to each record of the failure state description data 33 accumulated as history data and the failure state description about the device to be repaired 2B. As the degree of similarity, for example, the cosine similarity indicated by the following Formula (1) can be used. In Formula (1), the vector q indicates the document vector of the failure state description of the faulty device 2A, whereas the vector q indicates the document vector of the failure state description of the device to be repaired 2B. The value of the cosine similarity is in the range from −1 to +1, and the higher the degree of similarity of the two document vectors, the closer the value is to +1.

$$\begin{matrix}[ Formula 1 ] & \\ cos ( \vec{q} \cdot \vec{d} ) = \frac{{q}_{1} {d}_{1} + {q}_{2} {d}_{2} + … + {q}_{n} {d}_{n}}{\sqrt{{q}_{1}^{2} + {q}_{2}^{2} + … + {q}_{n}^{2}} \sqrt{{d}_{1}^{2} + {d}_{2}^{2} + … + {d}_{n}^{2}}} = \frac{\vec{q} \cdot \vec{d}}{\vert \vec{q} \vert \vert \vec{d} \vert} & ( 1 )\end{matrix}$$

Next, in step SP54, the repair content prediction unit 23 determines whether the maximum value of the degree of similarity calculated in step SP53 is equal to or greater than a predetermined threshold.

When the maximum value of the degree of similarity is less than the threshold (step SP54: NO), next, in step SP55, the repair content prediction unit 23 selects the second prediction model 352 as the repair content prediction model used for predicting the repair content candidate for the device to be repaired 2B.

When the maximum value of the degree of similarity is equal to or greater than the threshold (step SP54: YES), next, in step SP56, the repair content prediction unit 23 calculates the accuracy evaluation value of each of the first prediction model 351, the second prediction model 352, and the third prediction model 353. The repair content prediction unit 23 inputs the failure state description data 33 into the first prediction model 351, and compares the output first repair content candidate with the repair record data 34 to calculate the accuracy evaluation value of the first prediction model 351. The repair content prediction unit 23 inputs the operation history data 32 into the second prediction model 352, and compares the output second repair content candidate with the repair record data 34 to calculate the accuracy evaluation value of the second prediction model 352. The repair content prediction unit 23 inputs the operation history data 32 and the failure state description data 33 into the third prediction model 353, and compares the output third repair content candidate with the repair record data 34 to calculate the accuracy evaluation value of the third prediction model 353. As the accuracy evaluation value, for example, precision, recall, or accuracy, which are evaluation indices of the mixture matrix, can be used. The mixture matrix is a matrix in which a combination of two types of prediction content that there is a failure or that there is no failure, and two types of correct content that there is a failure or that there is no failure is grouped into 2 rows×2 columns as four types of elements. Precision is indicated by the following Formula (2), recall is indicated by the following Formula (3), and accuracy is indicated by the following Formula (4). In these formulas, N denotes the total number of samples corresponding to the size of the evaluation set, i denotes the number of each sample, Y denotes the set of predicted values, and T denotes the set of correct values. ∥ denotes the number of elements in the set within the symbol.

$$\begin{matrix}[ Formula 2 ] & \\ Precision = \frac{1}{N} {\sum }_{i = 1}^{N} \frac{\vert {Y}_{i} ⋂ {T}_{i} \vert}{\vert {Y}_{i} \vert} & ( 2 )\end{matrix}$$

$$\begin{matrix}[ Formula 3 ] & \\ Recall = \frac{1}{N} {\sum }_{i = 1}^{N} \frac{\vert {Y}_{i} ⋂ {T}_{i} \vert}{\vert {T}_{i} \vert} & ( 3 )\end{matrix}$$

$$\begin{matrix}[ Formula 4 ] & \\ Accuracy = \frac{1}{N} {\sum }_{i = 1}^{N} \frac{\vert {Y}_{i} ⋂ {T}_{i} \vert}{\vert {Y}_{i} ⋃ {T}_{i} \vert} & ( 4 )\end{matrix}$$

The desired accuracy evaluation value can be selected according to the field situation of the on-site repair service. For example, by using precision as the accuracy evaluation value, the possibility of revisiting is higher, but it will be possible to reduce the number of parts the service engineer brings for the on-site repair service. By using recall as the accuracy evaluation value, the number of parts the service engineer brings will increase, but it is possible to reduce the possibility of revisiting in the on-site repair service.

Next, in step SP57, the repair content prediction unit 23 selects the model with the highest accuracy evaluation value among the first prediction model 351, the second prediction model 352, and the third prediction model 353 as the repair content prediction model to use in the prediction of the repair content candidate for the device to be repaired 2B.

Following step SP55 or step SP57, next, in step SP58, the repair content prediction unit 23 uses the selected repair content prediction model to predict the repair content candidate for the device to be repaired 2B.

When the first prediction model 351 is selected as the repair content prediction model, the repair content prediction unit 23 inputs the failure state description data 33 about the device to be repaired 2B acquired by the acquisition unit 21 into the first prediction model 351. Accordingly, the first repair content candidate for the device to be repaired 2B is output. When the second prediction model 352 is selected as the repair content prediction model, the repair content prediction unit 23 inputs the operation history data 32 about the device to be repaired 2B acquired by the acquisition unit 21 into the second prediction model 352. Accordingly, the second repair content candidate for the device to be repaired 2B is output. When the third prediction model 353 is selected as the repair content prediction model, the repair content prediction unit 23 inputs the failure state description data 33 about the device to be repaired 2B acquired by the acquisition unit 21 into the first prediction model 351, and inputs the operation history data 32 about the device to be repaired 2B acquired by the acquisition unit 21 into the second prediction model 352. Accordingly, the first repair content candidate output from the first prediction model 351 and the second repair content candidate output from the second prediction model 352 are input into the third prediction model 353, and as a result, the third repair content candidate for the device to be repaired 2B is output from the third prediction model 353. Alternatively, when the third prediction model 353 is selected as the repair content prediction model, the repair content prediction unit 23 may input the failure state description data 33 and the operation history data 32 about the device to be repaired 2B acquired by the acquisition unit 21 into the third prediction model 353, and the third prediction model 353 may output the third repair content candidate.

The repair content candidate of each of the first repair content candidate, the second repair content candidate, and the third repair content candidate includes measure content candidates and part candidates. The repair content candidate may include a plurality of candidates and the confidence of each candidate for each of the measure content and parts. The unit of confidence is probability, such as percentage. The measure content includes replacement, cleaning, tightening, software update, or the like. The part includes the part name, model number, or the like of the part for which measures are to be taken.

Next, in step SP59, the output unit 24 outputs repair content data D4 indicating the repair content candidate predicted by the repair content prediction unit 23. The repair content data D4 output by the output unit 24 is input into the communication unit 13.

The communication unit 13 transmits the repair content data D4 input from the output unit 24 to the display device 4 via the communication network 6. By displaying the repair content candidate indicated by the repair content data D4 on a screen of the display device 4, the measure content candidate and part candidate are presented to the on-site repair service engineer.

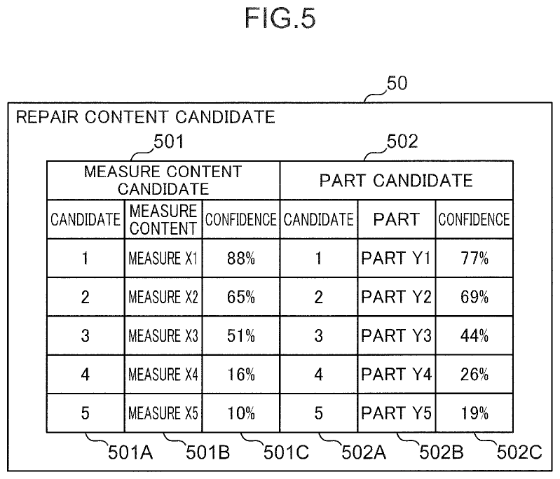

FIG. 5 is a diagram showing one example of a repair content candidate screen 50 displayed on the display device 4. The repair content candidate screen 50 includes a measure content candidate column 501 and a part candidate column 502. The measure content candidate column 501 includes a candidate area 501A, a measure content area 501B, and a confidence area 501C. The candidate area 501A shows, for example, ranking of candidates from first to fifth. The measure content area 501B shows measures X1 to X5 that are measure content corresponding to each of the ranking. The confidence area 501C shows confidence of respective measures X1 to X5. The part candidate column 502 includes a candidate area 502A, a part area 502B, and a confidence area 502C. The candidate area 502A shows, for example, ranking of candidates from first to fifth. The part area 502B shows parts Y1 to Y5 corresponding to each of the ranking. The confidence area 502C shows confidence of respective parts Y1 to Y5.

When repair of the faulty device 2A is complete, the service engineer inputs repair record data D3 indicating repair record information about repair content actually executed into the input device 5 by a keyboard operation, voice input, or the like. The input device 5 transmits the input repair record data D3 to the server device 1 via the communication network 6. The server device 1 stores the repair record data D3 received from the input device 5 in the storage unit 12 as one record of the repair record data 34, which is a database.

<Learning Phase>

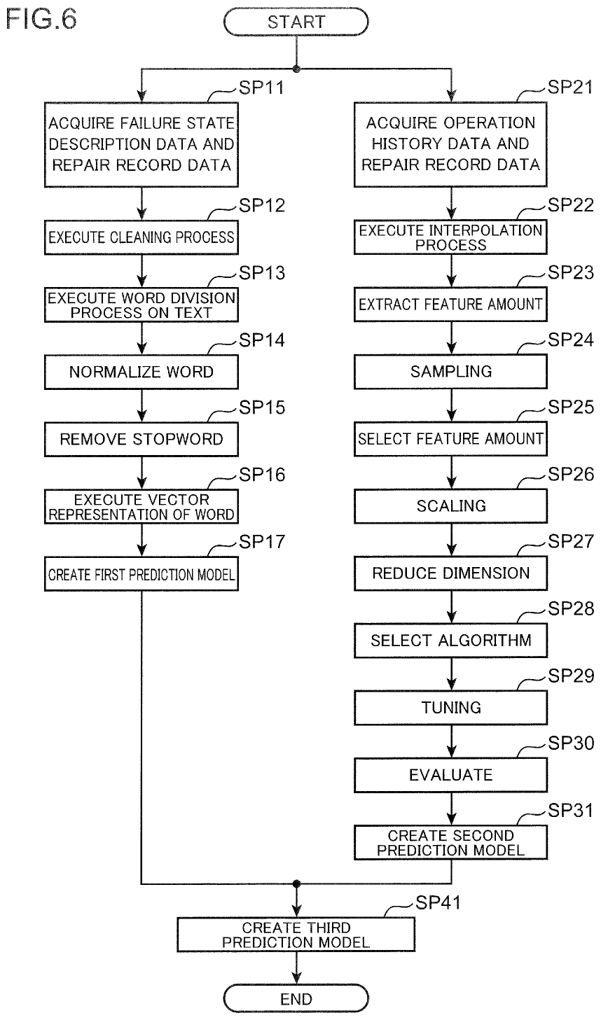

FIG. 6 is a flowchart showing a prediction model creation process by the prediction model creation unit 22.

To begin with, in step SP11, the prediction model creation unit 22 acquires the failure state description data 33 and the repair record data 34 by reading from the storage unit 12.

Next, in step SP12, the prediction model creation unit 22 removes noise included within text of the failure state description data 33 by executing a cleaning process.

Next, in step SP13, the prediction model creation unit 22 divides the text of the failure state description data 33, for example, by part of speech by executing a word division process on the text.

Next, in step SP14, the prediction model creation unit 22 unifies the character type, notation, or the like of words included in the failure state description data 33 by executing a word normalizing process.

Next, in step SP15, the prediction model creation unit 22 removes meaningless or useless words included in the failure state description data 33 by executing a stopword removal process.

Next, in step SP16, the prediction model creation unit 22 converts words (character strings) included in the failure state description data 33 into a vector by executing a vector representation process of words.

Next, in step SP17, the prediction model creation unit 22 creates the first prediction model 351 by machine learning using, as teacher data, the failure state description data 33 acquired by executing the process of steps SP12 to SP16 and the repair record data 34 corresponding to the failure state description data 33. The first prediction model 351 is a prediction model with the failure state description data 33 of the device to be repaired 2B as an explanatory variable and the first repair content candidate for the device to be repaired 2B as an objective variable. The prediction model creation unit 22 stores the created first prediction model 351 in the storage unit 12.

Meanwhile, in step SP21, the prediction model creation unit 22 acquires the operation history data 32 and the repair record data 34 by reading from the storage unit 12.

Next, in step SP22, the prediction model creation unit 22 executes outlier removal, interpolation of missing data, and the like on the operation history data 32 by executing an interpolation process.

Next, in step SP23, the prediction model creation unit 22 executes a feature amount extraction process on the operation history data 32. For example, by applying various combinations of a scaling process, arithmetic process, and aggregation process, the prediction model creation unit 22 creates a plurality of feature amounts from the operation history data 32.

Next, in step SP24, the prediction model creation unit 22 executes a sampling process on the operation history data 32 to apply clustering to the operation history data 32, which is time series data, into a plurality of highly correlated data groups.

Next, in step SP25, the prediction model creation unit 22 executes a selection process on the feature amount, which is an explanatory variable, on the operation history data 32. For example, by using forward selection of the wrapper method, the prediction model creation unit 22 gradually adds a significant feature amount that contributes to the improvement in the prediction accuracy.

Next, in step SP26, the prediction model creation unit 22 executes a data value scaling process, such as normalization, standardization, logarithmic transformation, or the like, on the operation history data 32.

Next, in step SP27, the prediction model creation unit 22 executes a dimension reduction process, if necessary, on the operation history data 32.

Next, in step SP28, the prediction model creation unit 22 executes a selection process of algorithm to be used for machine learning. The prediction model creation unit 22 tries a plurality of algorithms such as LightGBM, XGBoost, LSTM, and the like. The prediction model creation unit 22 creates the prediction model of each algorithm by machine learning using, as teacher data, the operation history data 32 acquired by executing the process of steps SP22 to SP27 and the repair record data 34 corresponding to the operation history data 32.

Next, in step SP29, by executing a tuning process, the prediction model creation unit 22 sets parameters for each algorithm selected in step SP28 to the optimal value with the highest prediction accuracy.

Next, in step SP30, by executing an evaluation process of the prediction model based on an error index, the prediction model creation unit 22 selects the feature amount and algorithm with the highest prediction accuracy.

Next, in step SP31, by selecting the optimal prediction model based on the evaluation result in step SP30, the prediction model creation unit 22 generates the second prediction model 352. The second prediction model 352 is a prediction model with the operation history data 32 of the device to be repaired 2B as an explanatory variable and the second repair content candidate for the device to be repaired 2B as an objective variable. The prediction model creation unit 22 stores the created second prediction model 352 in the storage unit 12.

Next, in step SP41, by combining the first prediction model 351 and the second prediction model 352 by stacking, blending, or the like, the prediction model creation unit 22 creates the third prediction model 353. In the use phase, the repair content prediction unit 23 predicts the third repair content candidate for the device to be repaired 2B by inputting the first repair content candidate by the first prediction model 351 and the second repair content candidate by the second prediction model 352 into the third prediction model 353. The prediction model creation unit 22 stores the created third prediction model 353 in the storage unit 12.

In addition to the third prediction model 353, the prediction model creation unit 22 stores the first prediction model 351 and the second prediction model 352 in the storage unit 12. In the use phase, the repair content prediction unit 23 predicts the first repair content candidate based on the failure state description data 33 about the device to be repaired 2B by using the first prediction model 351, and predicts the second repair content candidate based on the operation history data 32 about the device to be repaired 2B by using the second prediction model 352. Then, by using the third prediction model 353, the repair content prediction unit 23 predicts the third repair content candidate for the device to be repaired 2B based on the first repair content candidate and the second repair content candidate. This enables further improvement in the prediction accuracy of the repair content candidate.

Instead of the above example of creating the first prediction model 351 and the second prediction model 352 separately, the prediction model creation unit 22 may create the third prediction model 353 as a common prediction model using a data set of the operation history data 32, the failure state description data 33, and the repair record data 34 as teacher data.

### Advantageous Effects

According to the present embodiment, the data processing unit 11 as an information processing device acquires the operation history data 32 and the failure state description data 33 about the device to be repaired 2B, and predicts the repair content candidate for the device to be repaired 2B based on the learned repair content prediction model and the acquired operation history data 32 and the failure state description data 33. In this way, by predicting the repair content candidate by using not only the failure state description data 33, which is subjective information obtained from the user, but also the operation history data 32, which is objective information indicating the behavior of the device 2 until the device fails, it is possible to improve the prediction accuracy of the repair content candidate. As a result, in the on-site repair service, since the possibility of completing the repair of the device to be repaired 2B in one visit of the service engineer increases, it is possible to suppress unnecessary costs for revisiting and enhance user satisfaction.

### INDUSTRIAL APPLICABILITY

The present disclosure is particularly useful when applied to the on-site repair service system in which the service engineer visits the user's home or the like to repair the device to be repaired.

### REFERENCE SIGNS

1 server device
2 device
3, 5 input device
4 display device
11 data processing unit
12 storage unit
21 acquisition unit
22 prediction model creation unit
23 repair content prediction unit
24 output unit
31 program
32 operation history data
33 failure state description data
34 repair record data
351 first prediction model
352 second prediction model
353 third prediction model

1. A repair content prediction method comprising, by an information processing device:
acquiring operation history information and failure state description information about a device to be repaired;
predicting a repair content candidate for the device to be repaired based on a learned repair content prediction model and the acquired operation history information and the failure state description information; and
outputting the predicted repair content candidate.

2. The repair content prediction method according to claim 1, further comprising
selecting one of a first prediction model, a second prediction model, and a third prediction model as the repair content prediction model, wherein
the first prediction model is a model created by machine learning using, as teacher data, the failure state description information and repair record information about each of a plurality of faulty devices for which repair is previously executed, the model predicting a first repair content candidate based on the failure state description information,
the second prediction model is a model created by machine learning using, as teacher data, the operation history information and the repair record information about each of the plurality of faulty devices, the model predicting a second repair content candidate based on the operation history information, and
the third prediction model is a model created by machine learning using, as teacher data, the failure state description information, the operation history information, and the repair record information about each of the plurality of faulty devices, the model predicting a third repair content candidate based on the failure state description information and the operation history information.

3. The repair content prediction method according to claim 2, wherein
the third prediction model is created by combining the first prediction model and the second prediction model, and
the third repair content candidate is predicted by inputting the first repair content candidate and the second repair content candidate into the third prediction model.

4. The repair content prediction method according to claim 2, further comprising calculating a degree of similarity between history data on a plurality of pieces of the failure state description information that is previously acquired and the failure state description information about the device to be repaired, wherein
when the degree of similarity is less than a threshold, the second prediction model is selected as the repair content prediction model.

5. The repair content prediction method according to claim 4, further comprising calculating an accuracy evaluation value of each of the first prediction model, the second prediction model, and the third prediction model when the degree of similarity is equal to or greater than the threshold, wherein
a model of the first prediction model, the second prediction model, and the third prediction model with the highest accuracy evaluation value is selected as the repair content prediction model.

6. The repair content prediction method according to claim 5, wherein precision or recall is used as the accuracy evaluation value.

7. The repair content prediction method according to claim 1, wherein the repair content candidate includes a measure content candidate and a part candidate.

8. The repair content prediction method according to claim 7, wherein
the repair content candidate further includes confidence of the measure content candidate and confidence of the part candidate, and
the repair content prediction method further comprises transmitting data indicating the repair content candidate to a display device.

9. The repair content prediction method according to claim 1, wherein the device to be repaired is a battery for driving a travel motor mounted on a vehicle.

10. A repair content prediction device comprising:
an acquisition unit configured to acquire operation history information and failure state description information about a device to be repaired;
a prediction unit configured to predict a repair content candidate for the device to be repaired based on a learned repair content prediction model and the operation history information and the failure state description information acquired by the acquisition unit; and
an output unit configured to output the repair content candidate predicted by the prediction unit.

11. A computer-readable recording medium recording a program for causing an information processing device to execute:
acquiring operation history information and failure state description information about a device to be repaired;
predicting a repair content candidate for the device to be repaired based on a learned repair content prediction model and the acquired operation history information and the failure state description information; and
outputting the predicted repair content candidate.

12. A method for creating a repair content prediction model, the method comprising, by an information processing device, creating a repair content prediction model to predict repair content based on at least one of operation history information and failure state description information on a faulty device by machine learning using, as teacher data, the operation history information, the failure state description information, and repair record information about each of a plurality of the faulty devices for which repair is previously executed.
